(19) United States
(12) Patent Application Publication
(10) Pub. No.: US 2012/0095681 A1
(43) Pub. Date: Apr. 19, 2012

(54) MULTI-USER RELATIONSHIP-BASED NAVIGATION APPARATUS AND NAVIGATION MANAGEMENT METHOD USING THE SAME

(75) Inventors: Kyoung-Hwan AN, Daejeon (KR); Dong-Yong KWAK, Daejeon (KR); Dong-Sun LIM, Daejeon (KR)

(73) Assignee: Electronics and Telecommunications Research Institute, Daejeon-city (KR)

(21) Appl. No.: 13/242,071

(22) Filed: Sep. 23, 2011

(30) Foreign Application Priority Data
Oct. 15, 2010 (KR) 10-2010-0101044
Mar. 14, 2011 (KR) 10-2011-0022515

(51) Int. Cl. G01C 21/00

(52) U.S. Cl. 701/527; 701/400

(57) ABSTRACT

Disclosed herein is a multi-user relationship-based navigation apparatus. The multi-user relationship-based navigation apparatus includes a traveling situation information collection unit, a traveling situation information transmitting/receiving unit, a path information extraction unit, and a path display unit. The traveling situation information collection unit collects the traveling situation information of a user. The traveling situation information transmitting/receiving unit receives the common traveling situation information of other users in a multi-user relationship, and transmits the traveling situation information. The path information extraction unit extracts path information, related to paths on which the other users actually traveled, from the common traveling situation information. The path display unit displays a path to a destination of the user, the path being generated using the path information.

### CROSS REFERENCE TO RELATED APPLICATIONS

This application claims the benefit of Korean Patent Application Nos. 10-2010-0101044 and 10-2011-0022515, filed on Oct. 15, 2010 and Mar. 14, 2011, respectively, which are hereby incorporated by reference in their entirety into this application.

### BACKGROUND OF THE INVENTION

1. Technical Field

The present invention relates generally to a path providing service using a navigation apparatus in a vehicle, and, more particularly, to a technology which utilizes information about other users in a multi-user relationship in a predetermined relationship with a user or about neighboring users, thereby supplying a service for finding and providing an efficient path to a destination.

2. Description of the Related Art

A navigation apparatus is an apparatus for finding an optimal path to a destination and providing the found path to a user. With the increase of the use of vehicles, the navigation apparatus market also has rapidly expanded and research into more accurate navigation technology has been made. The current tendency is for navigation apparatuses to spread to include navigation technology for walkers due to the spread of smart phones, as well as navigation provided in outdoor vehicles. Information about the fastest or shortest path is provided to drivers or passengers.

Meanwhile, current navigation services have used a method of utilizing the stored map data of roads simply, and guiding a user through the shortest road to a destination. Current navigation services have also used a method wherein a navigation apparatus receives traffic information through Digital Multimedia Broadcasting (DMB), and provides a path finding result in such a way as to plan a path using roads in which traffic congestion is not severe or in such a way that a server reflects traffic information.

However, since such a method only enables a path to be found and provided to all the users using the same way, and focuses on fast arrival to a destination, there is a problem in that a customized path cannot be provided in consideration of the properties of user. Further, the results of path finding may not satisfy a user who knows a corresponding region well.

### SUMMARY OF THE INVENTION

An object of the present invention is to provide various paths to a user using path information of other users who are related to the user. In particular, the object of the present invention is to generate a path to a destination in consideration of the paths of one or more persons who are related to a user, thereby providing a navigation service that reflects the preferences and intention of the user rather than simply providing the fastest way.

In order to accomplish the above object, the present invention provides a multi-user relationship-based navigation apparatus according to an embodiment of the present invention, including: a traveling situation information collection unit for collecting the traveling situation information of a user; a traveling situation information transmitting/receiving unit for receiving the common traveling situation information of other users in a multi-user relationship in which traveling situation information is shared with the user, and transmitting the traveling situation information; a path information extraction unit for extracting path information, related to paths on which the other users actually traveled, from the common traveling situation information; and a path display unit for displaying a path to a destination of the user, the path being generated using the path information.

The multi-user relationship may be any one of a leader-follower relationship in which a leader provides the common traveling situation information to one or more followers who designated the corresponding leader, and a group relationship in which users in a group share the common traveling situation information with each other.

The path to the destination may be generated using any one of a complete following—type path finding method of generating a path to the destination in such a way as to exactly follow the path of the leader, and an inference-based following-type path finding method of generating a path to the destination in such a way as to use two or more paths of other users and preferentially consider a path through which many users have passed.

The complete following-type path finding method may be used to generate the path to the destination in such a way as to exactly follow the path of the leader from a crossing between the path of the leader and a path generated regardless of the path information.

Meanwhile, the path information includes one or more nodes corresponding to the crossings of roads, and links corresponding to the roads between the nodes; and the inference-based following-type path finding method is used to generate the path to the destination in such a way as to count the number of times that a plurality of links corresponding to the paths of the other users overlap, and to follow a link which has a highest count for each node from a node corresponding to a start point.

The path to the destination may be generated using only the path information of users, which is selected in consideration of any one or more of the number of followers of each of the other users, the locations of the other users, and time that the path information of the other users was collected.

For example, the path to the destination may be generated using only the path information of the other users, in which a path information maintenance period differently set based on the number of followers from among the other users, does not expire.

Meanwhile, the multi-user relationship may be dynamically established depending on whether the destination is shared, and configured to vary depending on the location of the user or the locations of the other users during traveling.

The common traveling situation information may include situation information which includes any one or more of surrounding image information, rapid speed reduction situation information, low speed situation information, path deviation information, accident information, and construction information; and the multi-user relationship-based navigation apparatus may further include a situation information display unit for displaying the situation information depending on whether the situation information is supposed to be displayed to the user.

The traveling situation information transmitting/receiving unit may receive only the common traveling situation information of the other users, the common traveling situation information being permitted to be shared with the user.

A multi-user relationship-based navigation management apparatus according to an embodiment of the present invention includes a multi-user relationship database for storing the user information of users in a multi-user relationship in which traveling situation information is shared; a multi-user relationship management unit for receiving the traveling situation information of the users and updating the multi-user relationship; a traveling situation information storage unit for storing the traveling situation information of the users; and a traveling situation information provision unit for providing the traveling situation information in response to a request from the users.

The multi-user relationship may be any one of a leader-follower relationship in which a leader provides the common traveling situation information to one or more followers who designated the corresponding leader, and a group relationship in which users in a group share the common traveling situation information with each other.

The multi-user relationship may be dynamically established depending on whether a destination is shared with a single user when the single user requests path finding, and may be configured to vary depending on the location of the single user or the locations of the other users in a multi-user relationship in the multi-user relationship during traveling.

The traveling situation information may include any one or more pieces of situation information which includes any one or more pieces of path information related to paths on which the users actually traveled, surrounding image information, rapid speed reduction situation information, low speed situation information, path deviation information, accident information, and construction information.

The traveling situation information transmitting/receiving unit provides only the traveling situation information of the users, the traveling situation information being permitted to be shared.

A multi-user relationship-based navigation method according to another embodiment of the present invention includes a traveling situation information transmitting/receiving unit receiving the common traveling situation information of other users in a multi-user relationship in which traveling situation information is shared with a user; a path information extraction unit extracting path information related to paths, on which the other users actually traveled, from the common traveling situation information; and a path display unit displaying a path to the destination of the user, the path being generated using the path information.

The multi-user relationship may be any one of a leader-follower relationship in which a leader provides the common traveling situation information to one or more followers who designated the corresponding leader, and a group relationship in which users in a group share the common traveling situation information with each other.

The path to the destination may be generated using any one of a complete following—type path finding method of generating the path to the destination in such a way as to exactly follow the path of the leader, and an inference-based following-type path finding method of generating the path to the destination in such a way as to use two or more paths of other users and preferentially consider a path through which many users have passed.

The path to the destination may be generated using only path information of users, which are selected in consideration of any one or more of the number of followers of each of the other users, the locations of the other users, and time that the path information of the other users was collected.

The multi-user relationship may be dynamically established depending on whether the destination is shared, and configured to vary depending on the location of the user or the locations of the other users during traveling.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a multi-user relationship-based navigation apparatus according to an embodiment of the present invention;

FIG. 2 is a block diagram illustrating a multi-user relationship-based navigation management apparatus according to the embodiment of the present invention;

FIG. 3 is a view illustrating an example of the leader-follower relationship of the multi-user relationship;

FIG. 4 is a view illustrating an example of the group relationship of the multi-user relationship;

FIG. 5 is a view illustrating an example of path information of a plurality of users;

FIG. 6 is a view illustrating an example of generating a path to a destination in a complete following-type path finding method;

FIG. 7 is a view illustrating an example of generating a path to a destination in an inference-based following-type path finding method;

FIG. 8 is a view illustrating a first example of the execution screen of the multi-user relationship-based navigation apparatus according to an embodiment of the present invention;

FIG. 9 is a view illustrating a second example of the execution screen of the multi-user relationship-based navigation apparatus according to an embodiment of the present invention;

FIG. 10 is a flowchart illustrating a multi-user relationship-based navigation method according to an embodiment of the present invention;

FIG. 11 is a flowchart illustrating a method of establishing a multi-user relationship; and

FIG. 12 is a flowchart illustrating a method of generating path information.

### DESCRIPTION OF THE PREFERRED EMBODIMENTS

A multi-user relationship-based navigation management apparatus and method according to an embodiment of the present invention will be described in detail below with reference to the attached drawings. In the following description, it should be understood that the same reference numerals are used to designate the same components.

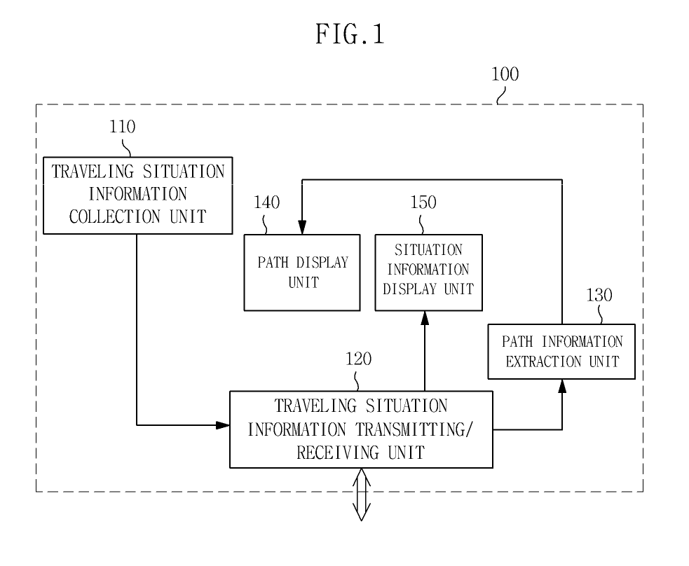

FIG. 1 is a block diagram illustrating a multi-user relationship-based navigation apparatus according to an embodiment of the present invention.

Referring to FIG. 1, a multi-user relationship-based navigation apparatus 100 according to the embodiment of the present invention includes a traveling situation information collection unit 110, a traveling situation information transmitting/receiving unit 120, a path information extraction unit 130, and a path display unit 140. Additionally, a situation information display unit 150 may be further included.

The traveling situation information collection unit 110 performs a function of collecting information about traveling situation of a user (hereinafter referred to as “traveling situation information”). The user's traveling situation information may include all the information which can be collected by the navigation apparatus 100 from among information about the circumstance of a vehicle on which the navigation apparatus 100 is mounted.

For example, there may be path information which can be collected in such a way that a user searches for a path using the navigation apparatus 100 and actually travels to a destination. That is, history information about traveling paths might be collected. When path information is collected and managed, the path information may be managed in such a way as to analyze nodes corresponding to road crossings and links between nodes, which correspond to roads.

In addition to the path information, the traveling situation information may include situation information. The situation information may include, for example, information about surrounding images of the navigation apparatus 100. The information about surrounding images means information about surrounding accidents and information obtained in such a way that the road status or the like are directly captured by the navigation apparatus 100 of the user.

The situation information may include one or more of information about a situation in which a vehicle rapidly decelerates, information about a situation in which the speed of a vehicle is lower than the predetermined speed of a road on a current path, information notifying that a vehicle has deviated from a found path, information about a vehicle accident, and information about the construction around a road, in addition to the information about surrounding images.

The situation information may be coupled to path information, thereby generating traveling situation information. For the purpose of efficient utilization of information, information about the location of a vehicle, measured by the navigation apparatus 100, may operate in conjunction with the situation information when the situation information is generated. In this way, the situation information is coupled to a location corresponding to each path of the path information, so that another user can check information collected at each location while the user moves along the path.

Therefore, the traveling situation information collection unit 110 may include means for collecting both the path information and the situation information. For example, a separate camera may be installed so that the entire surface of a vehicle can be captured depending on a location in which the navigation apparatus is provided, or the traveling situation information collection unit 110 may operate in conjunction with a rear camera and a black box which are installed in the vehicle. Further, the traveling situation information collection unit 110 may be connected to the vehicle speed sensor of a vehicle such that vehicle speed information can be collected.

When the situation information is collected, the traveling situation information collection unit 110 may select a method of a user manually collecting situation information or a method of a system automatically collecting situation information. The method of manually collecting situation information is a method in which situation information is collected in such a way that, whenever a specific event occurs, a user captures images or videos using a camera or a Global Positioning System (GPS), which is provided in a smart phone or the navigation apparatus 100, and then transmits the captured images or videos to a management server.

The method of automatically collecting situation information is a method in which situation information is automatically generated by a system when a specific event occurred along a path on which a driver actually traveled from a start point to a destination. For example, path information related to a path on which a driver actually traveled from a start point to a destination may be automatically collected when the driver arrives at the destination. Further, when any one of situations, in which a vehicle speed rapidly decreases, in which a vehicle travels with a speed lower than the predetermined speed of a road for a specific time or more and in which a vehicle deviates from a found path and travels, occurs, information about the occurrence of a situation may be automatically collected. Further, when there is the danger of collision, the traveling situation information collection unit 110 operates in conjunction with one or more sensors in a vehicle, so that information about accidents may be automatically generated. Here, images are continuously captured for a predetermined time, so that image information may be also collected together with information about the occurrence of an event.

The traveling situation information transmitting/receiving unit 120 performs functions of receiving the common traveling situation information of other users in a multi-user relationship in multi-user relationship in which the traveling situation information is shared with a user, and of transmitting the traveling situation information of the user to the outside. Here, the common traveling situation information has its commonly understood meaning of the traveling situation information collected by other users.

The multi-user relationship means that networking is set up such that a user may share traveling situation information with other users. For example, a relationship established between a user and other users in a multi-user relationship in a club to which the user belongs may also be included in the multi-user relationship. Further, in the case of path finding, a user may form a relationship with other users in real time depending on the locations of other users and depending on whether the same destination is searched for, and such a relationship may be also included in the multi-user relationship.

In the embodiment of the present invention, the multi-user relationship may be any one of a leader-follower relationship and a group relationship. The leader-follower relationship is a relationship in which a leader provides traveling situation information to followers who designated the corresponding leader, and the group relationship is a relationship in which users in a group share traveling situation information with each other.

The leader-follower relationship may be established in such a way that, if a follower designates a leader, the leader accepts. Thereafter, if the leader shares traveling situation information, the follower may utilize the corresponding information. As an example of this relationship, a driver who knows the roads of a specific region becomes a leader and the other drivers become followers.

The group relationship may be established in such a way that group members joins a previously or dynamically generated group. Such a relationship allows the traveling situation information of each user to be shared and utilized between group members. For example, the case of a user joining a travel club may correspond to the group relationship.

It is apparent that the establishment unit of the multi-user relationship may be realized as a relationship between a group and a user and a relationship between groups as well as a relationship between users. For example, between a group and a user, an individual who does not belong to a group may be a follower in such a way as to designate the corresponding group as a leader. That is, in that relationship, a user utilizes traveling situation information shared in public by a navigation company or a travel expert group. In addition, a relationship between groups, in which a club forms a relationship with another club, may also be realized.

The point in time when the multi-user relationship is established may include both the time before a user requests path fording and the time that the user requests the path finding. For example, a multi-user relationship may be previously established between users registered on a navigation-related website which supports the multi-user relationship, or a multi-user relationship registered on the Internet may be linked to the navigation-related website. In this case, the navigation apparatus 100 may include a function of previously displaying the registered multi-user relationship such that a user can select the multi-user relationship.

Meanwhile, even if the multi-user relationship was not previously established, when a user requests path finding, the multi-user relationship may be dynamically established during travel in such a way that groups of users are formed based on specific reference. Here, the user may individually and previously set whether to dynamically establish a multi-user relationship using an input operation.

For example, a leader-follower relationship may be established between users of vehicles heading for the same destination from among vehicles which are traveling on the road. In this case, a leader-follower relationship may be sequentially established in the order of distance which is near to the destination within a specific distance range. In this case, each vehicle transmits information about the location and destination of the corresponding vehicle to a server using the navigation apparatus 100. The server may vary the leader-follower relationship in real time depending on the locations of users based on the destination. The reason for this is that the distance to the destination may vary for each user depending on the speed of the vehicle and the situation on the road.

The traveling situation information transmitting/receiving unit 120 receives common traveling situation information which corresponds to the traveling situation information of other users, and transmits its traveling situation information. A method of transmitting/receiving information may be exemplified as follows. First, there may be a method of uploading traveling situation information collected using the navigation apparatus 100 to a server via a mobile communication network (for example, Wideband Code Division Multiple Access (WCDMA)), and transmitting the traveling situation information to other users who will share the information, via the mobile communication network.

Next, there may be a method of transmitting information to neighboring vehicles, such as vehicles in the rear, using Vehicle-to-Infrastructure (V2I) communication which is a wireless communication between a vehicle and an infrastructure or Vehicle-to-Vehicle (V2V) communication which is wireless communication between vehicles, without passing through a server. Here, in order to prevent excessive increases in the amount of information to be transmitted, the transmission of information may be restricted to a specific distance from a subject which transmits information or may be restricted depending on the number of relationship connections (the number of transmissions until connection is made).

When traveling situation information is transmitted or received, personal security should be considered. The reason for this is that traveling situation information includes personal information, such as the location of an individual and paths to which the individual had visited. Therefore, a user can control whether to open the travel situation information using an input operation for respective users or for respective travel in addition to the transmission of the traveling situation information to people included in the corresponding multi-user relationship. The user can protect personal privacy in such a way as to make the settings such that all the traveling situation information collected by the user is not shared or information about specific traveling is shared. That is, when the user receives traveling situation information, the user can receive only that common traveling situation information which is permitted to be shared.

The path information extraction unit 130 performs a function of extracting path information related to paths on which other users actually traveled from the common traveling situation information. The common traveling situation information received by the navigation apparatus 100 may include situation information in addition to path information collected using the navigation apparatuses of other users. In order to generate an optimal path based on the multi-user relationship, the path information extraction unit 130 extracts path information from common traveling situation information.

When path information is extracted, path information may be extracted by extracting nodes and links as described about the path information. Since the subject for generating the path information may be any one of internal and external servers of the navigation apparatus 100, the path information extraction unit 130 may transmit the extracted path information to the corresponding server again or the path display unit 140 depending on the subject for generating path information. When path information is extracted from the external server, it may not be necessary to configure the path information extraction unit 130.

The path display unit 140 performs a function of displaying a path to the destination of a user, which is generated using the extracted path information. The path to the destination of a user, which is generated in the embodiment of the present invention, may be selected by a user using a single path finding mode as in a recommended path and the shortest path which are provided in the prior art navigation apparatus.

A method of generating a path to a destination includes a complete following-type path finding method and an inference-based following-type path finding method. Whether to use the complete following-type path finding method or the inference-based following-type path finding method may vary based on selection information previously input by a user. For example, when a destination is searched for, a menu, asking which path finding method will be selected from the two methods, will be displayed on the navigation apparatus 100.

In the complete following-type path finding method, a path to a destination is generated in such a way that the path of a leader is completely followed. Here, although the path, on which the leader traveled to the destination in the past, may completely coincide with the path of a user, there are many cases in which the path of the leader does not completely coincide with the path of the user. The reason for this is that the start point of a leader may be different from those of followers. Therefore, in the complete following-type path finding method, path information related to a path on which a leader finally and actually traveled in order to reach a destination is compared with path information generated regardless of the path information of the leader using a general path finding engine. A finding engine, using the Dijkstra algorithm used to find a path in such a way as to search each of nodes for the shortest node in order to obtain the shortest distance or using the A* algorithm used to connect nodes in the order of heuristic estimation values when the shortest distance is obtained, may be exemplified as the general path finding engine.

Thereafter, the crossing of the two compared paths is found, and the path of the leader is exactly followed from the crossing, thereby generating a path to the destination. The complete following-type path finding method is a method of utilising the path of one person whom the user follows, and may be very usefully utilized when a person who knows the corresponding roads very well is selected as a leader.

In the inference-based following-type path finding method, paths are basically generated for respective nodes and links as described in the path information. It is apparent that the crossing between the path of a leader and the path of a user may be also set to a node in the complete following-type path finding method.

The inference-based following-type path finding method utilizes path information about the paths of leaders or group members whom a user who is a requester for path finding follows. Here, the number of times that a plurality of links, included in a path to a destination, are overlapped is counted. That is, the number of times that other users passed through a single link is counted. The reason for this is to prioritize roads over which many people pass.

Thereafter, a path to a destination is generated in such a way as to follow a link, which has the largest count for overlap at every node, from a node corresponding to the start point. When there is no count for overlap, a path generated by the navigation apparatus 100 of the user using a general algorithm will be followed as described above.

When a path to a destination is generated, a customized path should be provided using path information corresponding to a large amount of data. Therefore, data is accumulated and the amount of calculations increase more than necessary when a path is found, so that a phenomenon that the speed of path finding decreasing may occur. For this, such a problem may be solved by restricting any one of the amount of common traveling situation information received by the traveling situation information transmitting/receiving unit 120, the amount of path information extracted by the path information extraction unit 130, and the amount of path information utilized when a path is generated.

A method of restricting the amount of path information may include various methods. For example, only the path information of users selected from among other users based on the number of followers may be used. Only the path information of users corresponding to a predetermined number or less is used based on the number of followers.

Further, information about the locations of other users may be utilized, so that only path information of users who are located within a predetermined radius from a specific user may be utilized. Further, the time when path information was collected may be considered. That is, only path information collected within a predetermined time is considered and old path information is not considered, so that accuracy may increase when paths are collected.

Two or more methods may be simultaneously used as the above-described method of restricting the amount of path information. For example, the holding period of path information may be differently set based on the number of followers from among other users. A user who has a large number of followers means that the reliability of the user is high, so that the path information of such a user is retained for a long time, thereby increasing the accuracy of path fording. Further, only path information corresponding to a specific number or less may be utilized.

The multi-user relationship-based navigation apparatus 100 according to the embodiment of the present invention may further include a situation information display unit 150. The situation information display unit 150 performs a function of displaying situation information depending on whether there is display situation information included in the above-described traveling situation information that needs to be displayed. The situation information may be basically displayed in such a way as to operate in conjunction with the path information, may be displayed on the path information, or may be displayed using a separate window. Further, situation information includes location information as described above, so that the situation information may be displayed on a path corresponding to a location on which a corresponding situation occurred.

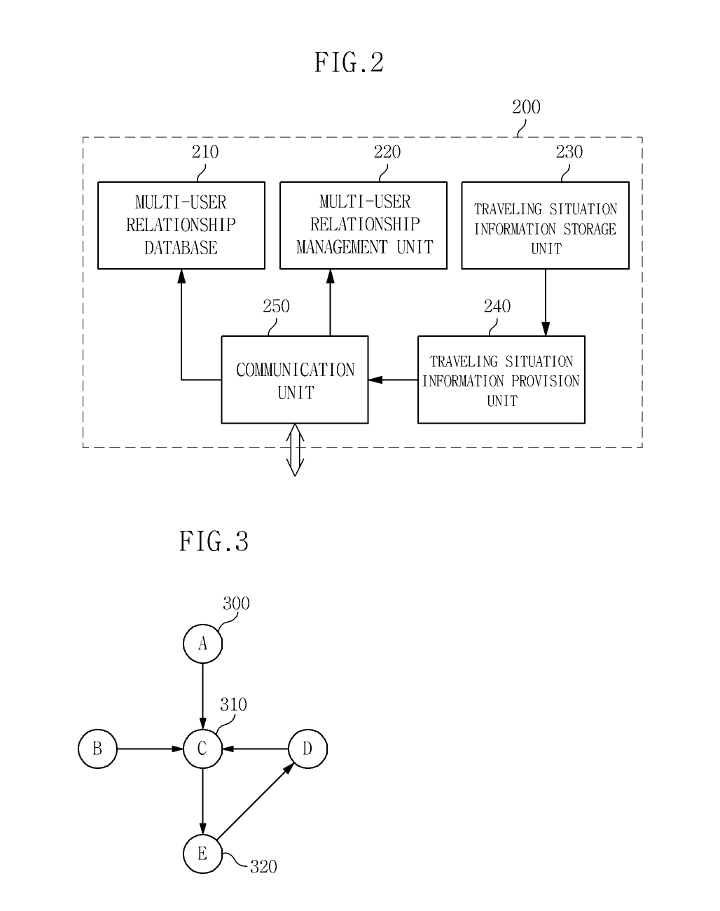

FIG. 2 is a block diagram illustrating a multi-user relationship-based navigation management apparatus according to the embodiment of the present invention. In the description below, the portions in which the description thereof are the same as those of the portions of FIG. 1 will be omitted.

The multi-user relationship-based navigation management apparatus 200 according to the embodiment of the present invention includes a multi-user relationship database 210, a multi-user relationship management unit 220, a traveling situation information storage unit 230, a traveling situation information provision unit 240, and a communication unit 250 for transmitting/receiving various types of data.

The multi-user relationship database 210 performs a function of storing user information of users in a multi-user relationship which is sharing traveling situation information. The user information may include information indicating whether a user wants to share his/her traveling situation information with other users, tag information about a multi-user relationship in which the user is included, user identification information, current location information, and information about a currently found path.

The multi-user relationship management unit 220 performs a function of receiving the traveling situation information of users and updating a multi-user relationship. For example, when a multi-user relationship is dynamically established, a leader-follower relationship may continuously vary based on the distance to a destination. Therefore, the multi-user relationship management unit 220 receives the traveling situation information of users in real time, and varies and updates the leader-follower relationship based on the received traveling situation information of users.

Besides, a multi-user relationship may be updated regardless of traveling situation information. For example, when a user leaves a club to which the user belonged or a user joins another club, a multi-user relationship may be updated based on user information.

The traveling situation information storage unit 230 stores the traveling situation information of users. A user may transmit traveling situation information collected by using the navigation apparatus 100 to the management apparatus 200, and the transmitted traveling situation information is stored in the traveling situation information storage unit 230 for each user. It is apparent that traveling situation information can be updated.

The traveling situation information provision unit 240 provides traveling situation information in response to the request of users. As mentioned in the description of FIG. 1, the provision of traveling situation information may be restricted using various types of references. In particular, each user can select whether to permit the sharing of information with other users, thereby providing only traveling situation information in which sharing is permitted.

FIG. 3 is a view illustrating the leader-follower relationship of a multi-user relationship.

Referring FIG. 3, a leader-follower relationship may be formed between a plurality of users, and one person may function as both a leader and a follower. A user A 300 follows a user C 310, so that it can be known that a leader-follower relationship is formed between the user A 300 and the user C 310 in which the user C 310 functions as a leader and the user A 300 functions as a follower.

Setting is made such that the user C 310 is a leader of a total of three users including the user A 300. However, at the same time, the user C 310 forms a leader-follower relationship in which a user E 320 is a leader. At the same time, the user E 320 forms a relationship in which a user D is a leader. The followers can utilize the traveling situation information of their leaders.

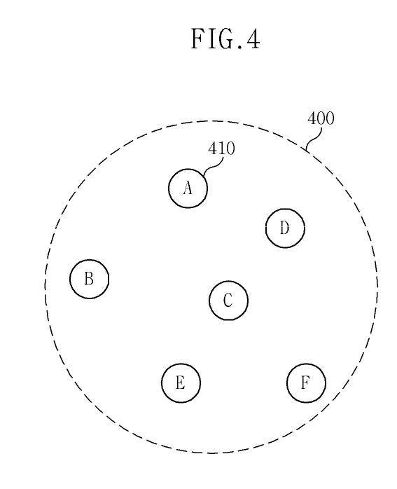

FIG. 4 is a view illustrating an example of the group relationship of a multi-user relationship.

Referring to FIG. 4, an example in which a single group 400 includes a plurality of users 410 may be seen. The plurality of users 410 are included in a single group. When this relationship is uploaded to the management apparatus 200 and the information of users is utilized, a plurality of users can share and utilize traveling situation information collected by the members of the group in which the users are included.

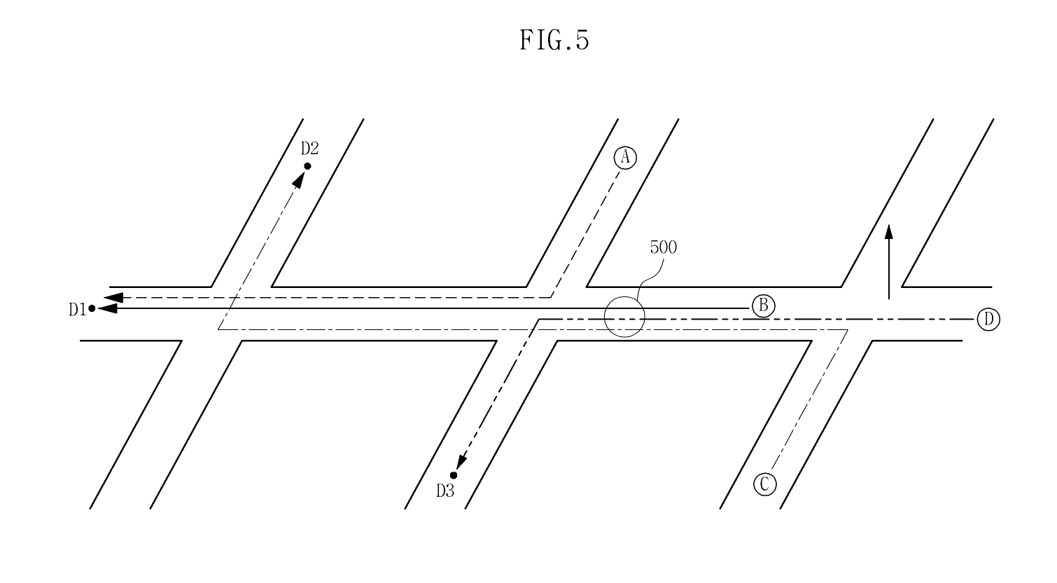

FIG. 5 is a view illustrating an example of the path information of a plurality of users. Referring to FIG. 5, the paths of respective users A, B, C, and D with respect to a first destination D1, a second destination D2 and a third destination D3 are displayed. The paths, travelled by users A and B heading for the first destination D1, user C heading for second destination D2, and user D heading for the third destination D3, are respectively displayed.

The paths of respective users may include an overlapping path 500. Such a path may have a good possibility of being selected as a path that a user should follow when a path to the destination of the user is found. In particular, in the case of the inference-based following-type path fording method, the rate of use will be high.

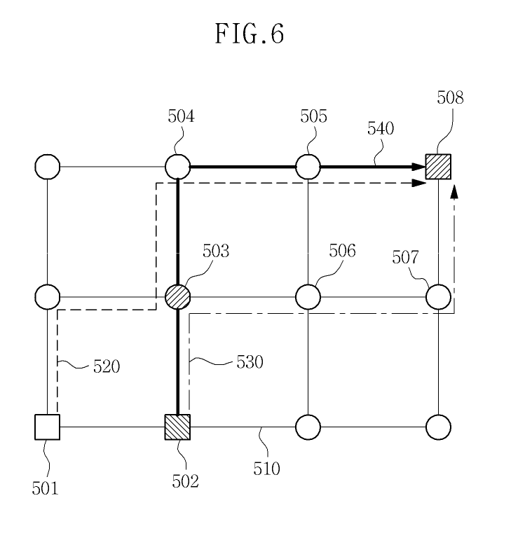

FIG. 6 is a view illustrating an example of generating a path to a destination using the complete following-type path finding method.

In the complete following-type path finding method, a node 502 at which a follower is located and a node 501 at which a leader is located may respectively exist. The leader may have information about links corresponding to a path 520 actually traveled in the past to a node 508 corresponding to a destination. A single link 510 is information corresponding to a road between two nodes. This may be basically managed using the traveling situation information storage unit 230.

Links corresponding to a path 530, found by using a general navigation service as mentioned in the description of FIG. 1, may be established for a user who is a follower. A node 503 corresponding to a crossing exists between the paths 520 and 530 of the follower and the leader. The crossing functions as a path selection reference in the complete following-type path finding method.

That is, with respect to a path generated using the complete following-type path finding method, up to the node 504 corresponding to the crossing, a path passing through the nodes 502 and 503 included in the path 530 found by using the general navigation service may be selected regardless of the path 520 of the leader, and from the node 503 corresponding to the crossing up to the node 508 corresponding to the destination, a path passing through nodes 503, 504, 505, and 508 which connect links included in the path 520 of the leader may be selected. Therefore, a path 540 to the destination is made in such a way as to connect the links between the nodes 502, 503, 504, 505, and 508. Therefore, the follower can generate and receive the path 540 to the destination by utilizing the path 520 of the leader.

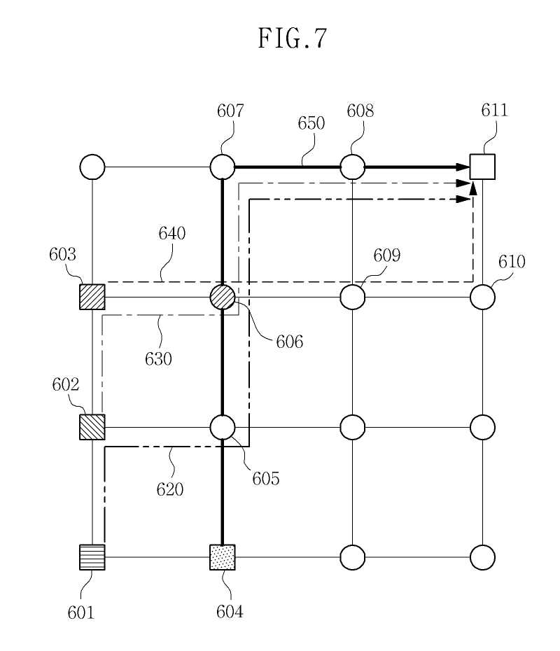

FIG. 7 is a view illustrating an example of generating a path to a destination using the inference-based following-type path finding method.

Referring to FIG. 7, in an inference mode, past path information of a leader and at least one group member is selected and analyzed first. In the inference mode, a path (not shown) found by using the navigation apparatus 100 of a user may be also established.

When the path information of a leader and a group member is selected, the path information is analyzed into a plurality of nodes and links. Nodes 601, 602 and 603 corresponding to the start points of the leader or the group members are found, and the links and nodes corresponding to paths 620, 630 and 640 on which the leader and the group members traveled to a node 611 which corresponds to the destination are extracted. Thereafter, the number of times that each link overlaps is counted. In the example of FIG. 7, links corresponding to the past paths 620, 630 and 640 of other users do not include any overlapping link at a node 604 which corresponds to the location of a user. Further, a link between nodes 605 and 606 corresponds to a link in which the past path exists for the first time when heading for the destination. Therefore, a link, corresponding to a path passing through the nodes 605 and 606 from the node 604 which corresponds to the start point of the user, is connected. At a node 606, an overlapping count, with respect to links passing through nodes 609 and 610 and then connecting to the node 611 corresponding to the destination, becomes 1. Further, an overlapping count with respect to links connecting to the nodes 606, 607, 608 and 611 becomes 2.

Consequentially, at the node 606, the overlapping count with respect to links connecting to the nodes 606, 607, 608 and 611 is the highest. Therefore, since a link which has the highest overlapping count is considered first in the inference-based following path finding, a path connecting from the node 604, which corresponds to a start point, to links between the nodes 605, 606, 607, 608 and 611 is generated as a path 650 to the destination in the inference-based following-type path finding method.

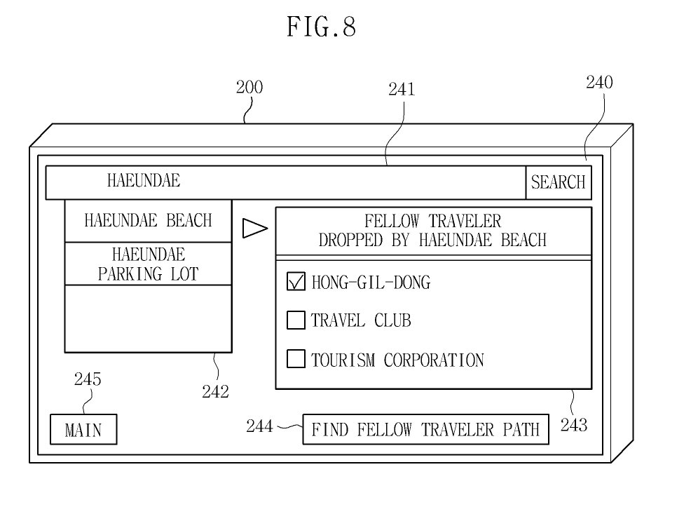

FIG. 8 is a view illustrating a first example of the execution screen of the multi-user relationship-based navigation apparatus according to an embodiment of the present invention.

As described above, an execution screen may have the same meaning as that of the path display unit 140 or the situation display unit 150. The path display unit 140 or the situation display unit 150 may be a screen including a touch-screen function. In this case, a user can check path information and input information about path finding using the path display unit 140 and the situation display unit 150.

The user finds a destination using a destination input menu 241. When the candidate group 242 of the destination is displayed as the result of finding the destination, the user selects the desired destination to go. Here, the path display unit 140 or the situation display unit 150 displays a list 243 of other users or groups which visited the destination.

At least one displayed fellow traveler means a leader or group member who established a relationship with a path finding requester. Here, when a button 244 for finding a fellow traveler path is clicked, a path to the destination is found and provided to the user using the path information of the fellow traveler based on the preset traveling path information utilization reference, as described above. With a main button 245, a user can use a function capable of setting whether to dynamically establish a multi-user relationship and whether to share traveling situation information with other users.

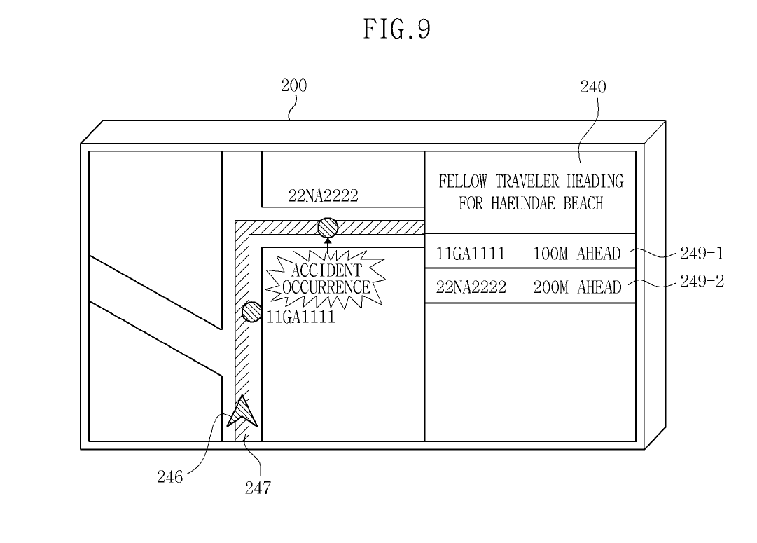

FIG. 9 is a view illustrating a second example of the multi-user relationship-based navigation apparatus according to an embodiment of the present invention.

Referring to FIG. 9, FIG. 9 shows an example of a screen displayed on the path display unit 140 or the situation display unit 150 when a user is actually traveling after the user has set a destination and has requested path finding using the menu illustrated in FIG. 8.

Guidance, in which a path to the destination is finally generated, starts. If a user wants to know one or more vehicles which are currently traveling to the same destination, the user may select a button which enables the user to select one or more neighboring fellow travelers. In this case, one or more pieces of information 249-1 and 249-2 about vehicles moving to the same destination, which correspond to users in a multi-user relationship dynamically set using a server, are output. Therefore, the user can view the locations of the respective vehicles on a screen, so that the user can follow the location of a vehicle in front as well as a generated path. Referring back to the screen, the screen includes an icon 246 which indicates the location of the vehicle of the current user, and a path 247 found by using the travel path information of other users based on the multi-user relationship is displayed. Further, on the path display unit 140 or the situation display unit 150, a menu which enables the fellow travelers 249-1 and 249-2 corresponding to other users that are heading for the same destination as that of the user to be displayed may be shown.

The user may also view the recommendation path 247 and the locations of the fellow travelers 249-1 and 249-2 using the path display unit 140 and the situation display unit 150. Here, a display and input unit 240 may display the situation of one or more events occurred in real time. For example, as shown in FIG. 9, when one or more images related to an accident are captured at the location of the single fellow traveler 249-2, the images are displayed such that the user can view the accident.

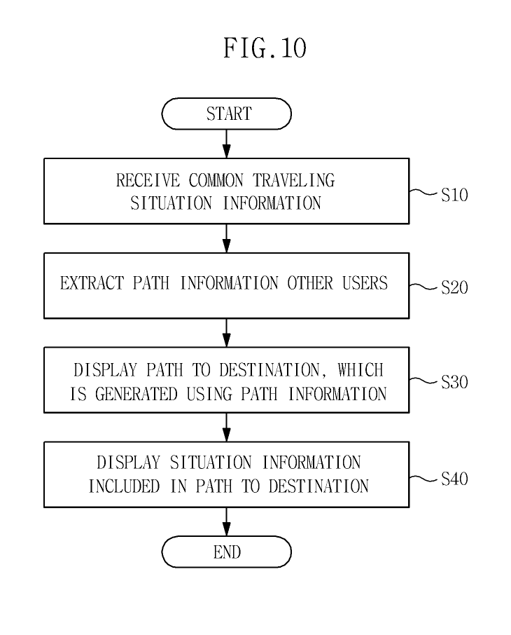

FIG. 10 is a flowchart illustrating a multi-user relationship-based navigation method according to an embodiment of the present invention. In the description below, the portions in which the descriptions thereof are the same as those of the portions of FIGS. 1 to 9 will be omitted.

Referring to FIG. 10, in the multi-user relationship-based navigation method according to the embodiment of the present invention, the traveling situation information transmitting/receiving unit 120 receives common traveling situation information collected by other users first at step S10. Here, the traveling situation information of users corresponding to the predetermined number or less based on a predetermined restriction condition may be received as described above.

Thereafter, the path information extraction unit 130 extracts the path information of other users from the received traveling situation information at step S20.

The path display unit 140 displays path information indicating a path to a destination, the path information being generated using the path information extracted at step S20, at S30. The path information indicating the path to the destination may be generated using any of the complete following-type path finding method and the inference-based following-type path fording method as described above.

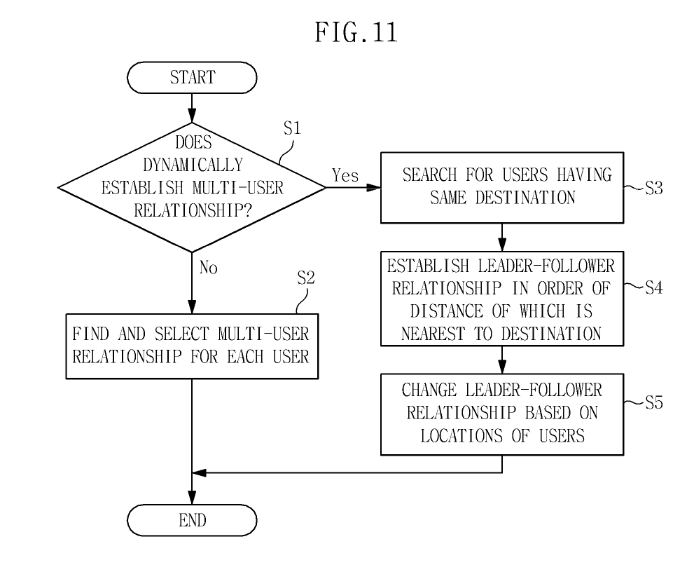

FIG. 11 is a flowchart illustrating a method of establishing a multi-user relationship.

Referring to FIG. 11, when a multi-user relationship is established, the multi-user relationship database 210 and the multi-user relationship management unit 220 receives first the determination of whether to dynamically establish the multi-user relationship using an input operation by a user at step S1.

If the user wants to dynamically establish the multi-user relationship, the multi-user relationship database 210 is searched for other users having the same destination as that of the user using user information at step S3. Thereafter, a leader-follower relationship is established in the order of distance which is the nearest to the destination using information about user location included in each of the user information at step S4, and then the leader-follower relationship varies in real time based on the location of each of the users.

If the user does not want to dynamically establish the multi-user relationship, the multi-user relationship database 210 is searched for a multi-user relationship related to the user and the corresponding multi-user relationship is selected at step S2. Here, the multi-user relationship database may be used to search for and select the multi-user relationship related to the user, used to search for and select information about a plurality of users in a multi-user relationship in the multi-user relationship related to the user, and used to transmit the traveling situation information of each of the users from the traveling situation information storage unit 230 to the traveling situation information transmitting/receiving unit 120.

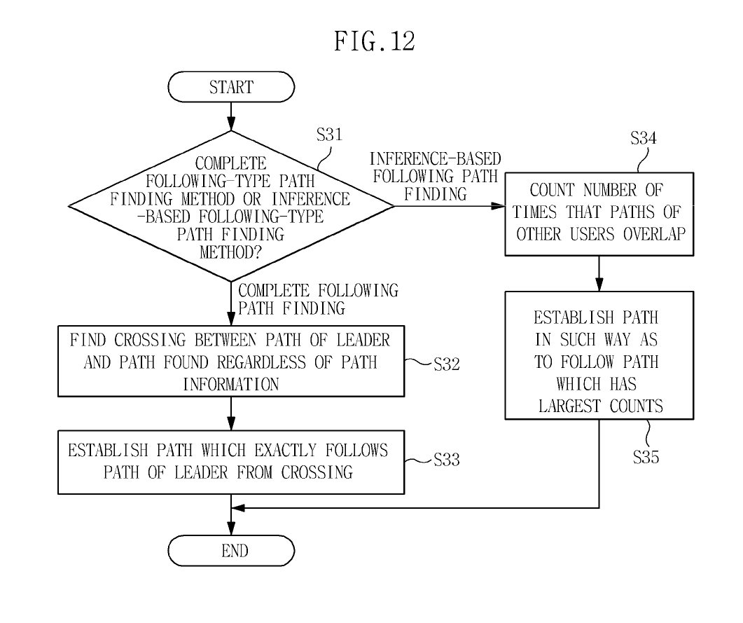

FIG. 12 is a flowchart illustrating an example of a method of generating path information.

Referring to FIG. 12, when the path information is generated, it is determined first whether to use the complete following-type path finding method or the inference-based following-type path finding method at step S31.

When the complete following-type path fording method is used, the crossing between a path on which a leader actually traveled and a path established using an existing navigation method, that is, a path found regardless of the path information, is found at step S32. The path established using the existing method is followed up to the crossing, and a path which exactly follows the path of the leader is established from the crossing at step S33.

When the inference-based following-type path finding method is used, path information is extracted from the traveling situation information of other users in a multi-user relationship, and then the number of times that paths to the destination overlap is counted at step S34. Thereafter, a path to the destination is generated by following the path which overlaps the largest number of times at step S35.

According to the present invention, a user can receive a navigation service using the information of neighboring users or other users who are related to the user attributable to social relationship such as a club to which the user belongs. Further, as well as path information, information about the traffic situation on a path may be easily utilized in such a way as to receive the corresponding path from other users who are included in a multi-user relationship, so that there is an advantage of providing a comprehensive navigation service.

The description of the above-described multi-user relationship-based navigation management apparatus and method according to the embodiment of the present invention does not limit the claims. Further, the equivalents which perform the same function as that of the present invention other than the present embodiment are included to the scope of rights of the invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multi-user relationship-based navigation apparatus, comprising:
a traveling situation information collection unit for collecting traveling situation information of a user;
a traveling situation information transmitting/receiving unit for receiving common traveling situation information of other users in a multi-user relationship in which traveling situation information is shared with the user, and transmitting the traveling situation information;
a path information extraction unit for extracting path information, related to paths on which the other users actually traveled, from the common traveling situation information; and
a path display unit for displaying a path to a destination of the user, the path being generated using the path information.

2. The multi-user relationship-based navigation apparatus as set forth in claim 1, wherein the multi-user relationship is any one of a leader-follower relationship in which a leader provides the common traveling situation information to one or more followers who designated the corresponding leader, and a group relationship in which users in a group share the common traveling situation information with each other.

3. The multi-user relationship-based navigation apparatus as set forth in claim 2, wherein the path to the destination is generated using any one of a complete following-type path finding method of generating a path to the destination in such a way as to exactly follow a path of the leader, and an inference-based following-type path finding method of generating a path to the destination in such a way as to use two or more paths of other users and preferentially consider a path through which many users have passed.

4. The multi-user relationship-based navigation apparatus as set forth in claim 3, wherein the complete following-type path finding method is used to generate the path to the destination in such a way as to exactly follow the path of the leader from a crossing between the path of the leader and a path generated regardless of the path information.

5. The multi-user relationship-based navigation apparatus as set forth in claim 3, wherein:
the path information comprises one or more nodes corresponding to crossings of roads, and links corresponding to the roads between the nodes; and
the inference-based following-type path finding method is used to generate the path to the destination in such a way as to count a number of times that a plurality of links corresponding to the paths of the other users overlap, and to follow a link which has a highest count for each node from a node corresponding to a start point.

6. The multi-user relationship-based navigation apparatus as set forth in claim 5, wherein the path to the destination is generated using only the path information of users, which is selected in consideration of any one or more of a number of followers of each of the other users, locations of the other users, and time that the path information of the other users was collected.

7. The multi-user relationship-based navigation apparatus as set forth in claim 6, wherein the path to the destination is generated using only the path information of the other users, in which a path information maintenance period differently set based on the number of followers from among the other users, does not expire.

8. The multi-user relationship-based navigation apparatus as set forth in claim 1, wherein the multi-user relationship is dynamically established depending on whether the destination is shared, and configured to vary depending on a location of the user or locations of the other users during traveling.

9. The multi-user relationship-based navigation apparatus as set forth in claim 1, wherein:
the common traveling situation information comprises situation information which comprises any one or more of surrounding image information, rapid speed reduction situation information, low speed situation information, path deviation information, accident information, and construction information; and
the multi-user relationship-based navigation apparatus further comprises a situation information display unit for displaying the situation information depending on whether the situation information is supposed to be displayed to the user.

10. The multi-user relationship-based navigation apparatus as set forth in claim 1, wherein the traveling situation information transmitting/receiving unit receives only the common traveling situation information of the other users, the common traveling situation information being permitted to be shared with the user.

11. A multi-user relationship-based navigation management apparatus comprising:
a multi-user relationship database for storing user information of users in a multi-user relationship in which traveling situation information is shared;
a multi-user relationship management unit for receiving the traveling situation information of the users and updating the multi-user relationship;
a traveling situation information storage unit for storing the traveling situation information of the users; and
a traveling situation information provision unit for providing the traveling situation information in response to a request from the users.

12. The multi-user relationship based navigation management apparatus as set forth in claim 11, wherein the multi-user relationship is any one of a leader-follower relationship in which a leader provides the common traveling situation information to one or more followers who designated the corresponding leader, and a group relationship in which users in a group share the common traveling situation information with each other.

13. The multi-user relationship based navigation management apparatus as set forth in claim 11, wherein the multi-user relationship is dynamically established depending on whether a destination is shared with a single user when the single user requests path finding, and is configured to vary depending on a location of the single user or locations of the other users in a multi-user relationship in the multi-user relationship during traveling.

14. The multi-user relationship based navigation management apparatus as set forth in claim 11, wherein the traveling situation information comprises any one or more pieces of situation information which comprises any one or more pieces of path information related to paths on which the users actually traveled, surrounding image information, rapid speed reduction situation information, low speed situation information, path deviation information, accident information, and construction information.

15. The multi-user relationship based navigation management apparatus as set forth in claim 11, wherein the traveling situation information transmitting/receiving unit provides only the traveling situation information of the users, the traveling situation information being permitted to be shared.

16. A multi-user relationship-based navigation method comprising:
a traveling situation information transmitting/receiving unit receiving common traveling situation information of other users in a multi-user relationship in which traveling situation information is shared with a user;
a path information extraction unit extracting path information related to paths, on which the other users actually traveled, from the common traveling situation information; and
a path display unit displaying a path to a destination of the user, the path being generated using the path information.

17. The multi-user relationship-based navigation method as set forth in claim 16, wherein the multi-user relationship is any one of a leader-follower relationship in which a leader provides the common traveling situation information to one or more followers who designated the corresponding leader, and a group relationship in which users in a group share the common traveling situation information with each other.

18. The multi-user relationship-based navigation method as set forth in claim 17, wherein the path to the destination is generated using any one of a complete following-type path finding method of generating the path to the destination in such a way as to exactly follow a path of the leader, and an inference-based following-type path finding method of generating the path to the destination in such a way as to use two or more paths of other users and preferentially consider a path through which many users have passed.

19. The multi-user relationship-based navigation method as set forth in claim 17, wherein the path to the destination is generated using only path information of users, which are selected in consideration of any one or more of a number of followers of each of the other users, locations of the other users, and time that the path information of the other users was collected.

20. The multi-user relationship-based navigation method as set forth in claim 16, wherein the multi-user relationship is dynamically established depending on whether the destination is shared, and configured to vary depending on a location of the user or locations of the other users during traveling.
